(19) United States
(12) Patent Application Publication
(10) Pub. No.: US 2006/0124409 A1
(43) Pub. Date: Jun. 15, 2006

(54) High performance drum brake assembly for automotive braking system

(75) Inventors: Paravasaraju Raajha, Chennai (IN); Vaidyanathan Lakshmi Narayanan, Chennai (IN)

Correspondence Address: MERCHANT & GOULD PC, P.O. BOX 2903, MINNEAPOLIS, MN, 55402-0903, US

(73) Assignee: BRAKES INDIA LIMITED, Chennai (IN)

(21) Appl. No.: 10/521,043

(22) PCT Filed: Jun. 18, 2003
(86) PCT No.: PCT/IN03/00221

§ 371 Date: Aug. 12, 2005

(30) Foreign Application Priority Data
Jul. 11, 2002 (IN) 515/MAS/2002

(51) Int. Cl. F16D 51/00; F16D 65/14

(52) U.S. Cl. 188/74

(57) ABSTRACT

A High performance drum brake assembly design is developed which can substantially increase the brake output torque for a given hydraulic input pressure or reduce the required pipeline pressure to realize the current rated torque. The brake assembly has a new lever (17) pivoted on the leading shoe (19) web with one end resting on the wheel cylinder piston (11) and the other end on the strut assembly (15). This lever touches the piston instead of the leading shoe web and receives input from the pressurized wheel cylinder. The lever rotates about its pivot point (18) and pushes the strut assembly. The trailing shoe (3) receives two inputs, one from the wheel cylinder and the other from the strut assembly. The wheel cylinder input and the strut reaction force together acting on the pivot, results in almost twice the force acting on the leading shoe.

### FIELD OF INVENTION

This invention in general pertains to automobile technology. More particularly this invention pertains to automotive braking system. In particular, this invention relates to the design of a new drum brake assembly for automotive braking purposes.

At the outset of the description, which follows, it is to be understood that the ensuing description only illustrates a particular form of this invention. However, such particular form is only an exemplary embodiment, and without intending to imply any limitation on the scope of this invention.

### PRIOR ART

It is to be noted that the prior art description gives detail information of the technology, method, process and system known in the art, it explains the deficiency in the related art and the object of the invention being to overcome or surmount the problem associated with the prior art. This forms the essential feature and the object of the invention.

With continuous improvement in engine technology, better roads, increasing cruising speeds and stringent statutory/regulatory requirements, there is an inherent need to develop safer braking systems to meet this requirement. Also, to cater to the increasing vehicle weights, increasing speeds and to offer improved braking performance, hydraulic drum brake assemblies have increased in size from φ7″ to φ12″ to date catering to the passenger car and utility vehicle applications.

Attempts to provide a good braking system resulted in providing better friction material and bigger diameter drum brakes predominantly for rear applications. Consequences to the above proposal are addressing brake squeal, consistency in brake lining performance, grabbing tendency, early morning sharpness, high fade, high lining wear and bigger actuation systems respectively.

Along with the increased cost associated with the above proposals, packaging bigger brakes within the available wheel size has always been a problem. To address the above issues, the current designs are studied and a new proposal is given which can overcome the above problems.

Besides increase in wheel cylinder and brake diameter, duo-servo design has been developed to increase the service & parking brake performance to cater to the requirement. Sensitivity of the duo-servo design to changes in friction level has put limitations on wide acceptance to this design.

With increasing wheel cylinder and brake diameters growing proportionately to meet the requirements, associated problems of increasing actuation requirements and packaging poses immense problems. Pedal effort reduction is also achieved either by increasing friction level or decreasing master cylinder size (notwithstanding impact on pedal travel) for a given braking system.

To address the above issues, a drum brake assembly is designed which can substantially increase the brake output torque for a given hydraulic input pressure or reduce the required pipeline pressure to realize the current rated torque compared to the conventional design.

This design as explained in the following section overcomes all the above constraints in meeting friction level, pedal efforts, cost and packaging requirements while also providing all the features of a drum brake.

As such for novelty of the invention, the published information in USA and European patents has been accessed and a list of sample cited patent documents given below cover the following patent specifications:

A cited PCT/US patent application having patent no WO 96/07833 dated Mar. 14, 1996 filed by HINO JIDOSHA KOGYO KABUSHIKI KAISHA relates to an invention having a rod set up in the inner surface of the rim to effectively reduce the screeching of a brake.

A cited European patent application having patent no 95306755 dated Sep. 25, 1995 filed by Ford Motor Company relates to an invention of a mass damper for attenuating objectionable noise.

A cited European patent application having patent no 95106211 dated Apr. 25, 1995 filed by Nisshinbo Industries Inc relates to an invention of a coloured strip for visual indication of the brake lining wear.

A cited PCT/US patent application having patent no WO 96/16275 dated May 30, 1996 filed by TOKYO BUHIN KOGYO CO LTD., relates to an invention of setting up different natural frequencies for the two shoes to reduce the possibility of a screeching sound.

A cited PCT/US patent application having patent no 6513632 dated Feb. 4, 2003 filed up TRW Automotive relates to an invention of an actuator with an electric drive motor and an electronic unit for parking brake actuation.

A cited PCT/US patent application having patent no 4646885 dated Mar. 3, 1987 filed by FORD Motor Company relates to an invention of a dual drum brake assembly to generate an enhanced brake torque.

A cited US patent application having patent no 4332311 dated Jun. 1, 1982 filed by Toyota Jidosha Kogyo Kabushiki Kaisha, JP relates to an invention of a shoe hold down, device in a drum brake.

A cited PCT/US patent application having patent no WO 92/20938 dated Nov. 26, 1992 filed by Automotive Products plc relates to an invention of an adjuster comprising a lever member and pawl member mounted on one brake shoe with a bimetallic strip to prevent adjustment at elevated temperatures.

On perusal of the cited documents with respect to our invention, it has been found prima-facie that our invention is unique and distinct from the cited inventions.

This invention, therefore, proposes a drum brake assembly for automotive applications, which has various objectives such as to furnish a greater braking force, than normally possible, to handle higher speeds, larger sizes and greater vehicle weights, without any abnormal change in the dimensions or weight associated with the normal, known drum brake assembly.

Further objects and advantages of the invention will become apparent from consideration of the drawings and the ensuing description.

The foregoing description of outlined rather broadly preferred and alternative feature of the present invention so that those skilled in the art may better understand the detailed description of the invention that follows. Additional features of the invention will be described hereinafter that forms the subject of claims of the invention. Those skilled in the art should appreciate that they can readily use the disclosed conception and specific embodiment as a basis for designing and modifying other structures for carrying out the same purposes of the present invention. Those skilled in the art should realize such equivalent conception do not depart from the spirit and scope of the invention in its broadest form.

### SUMMARY OF INVENTION

The inventors have made great effort to provide a system, which meets the requirement of the industry and overcome the problem associated in the prior art.

To achieve the above object according to first aspect and feature of the present invention, a system is provided by which the unutilized space on the leading shoes near the wheel cylinder is utilized so as to enhance the utility of the drum brake assembly for automotive braking system.

According to second aspect and feature of the invention in addition to the first feature of the invention, comprises the utilization of space by employing an additional lever arrangement and connected in such way to the existing lined shoe in order to increase the brake output torque for a given pipe line pressure compared to identical drum brake design.

Further objects of the invention will be clear from the ensuing description.

### BRIEF DESCRIPTION OF DRAWINGS

The accompanying drawings are intended to provide for the understanding of invention, incorporating in and constitute a part of invention. The drawings illustrate on embodiment of invention and together with the description illustrate principle of invention. The drawings are given by way of non-limitative example to explain the nature of the invention.

For complete understanding of the invention, reference is now made to the following description taken in conjunction with the accompanying drawings.

This invention will now be described in further detail with reference to the accompanying drawings which are illustrated in:

FIG. 1: Shows elevation of the known drum brake assembly

FIG. 2: Shows an embodiment of the elevation of the proposed drum brake assembly, by way of example and not by way of limitation, of the scope of this invention

FIG. 3: shows a schematic Sketch of the forces acting in the known drum brake assembly

FIG. 4: shows a schematic sketch of the forces acting in the high performance drum brake design

FIG. 5: shows a 3D model of the high performance drum brake assembly

FIG. 6: shows the 3D back view model of the high performance drum brake assembly

FIG. 7: shows a 3D model of the close-up view of the new lever arrangement on the lined leading shoe assembly

FIG. 8: shows a 3D model of the links used for the ADAMS analysis.

FIG. 9: shows a graph giving the input-output relationship of the conventional design and the High Performance design during dynamometer test at 25 kph equivalent vehicle speeds.

FIG. 10: shows a graph giving the input-output relationship of the conventional design and the High Performance design during dynamometer test at 50 kph equivalent vehicle speed.

FIG. 11: shows a graph giving the input-output relationship of the conventional design and the High Performance design during dynamometer test at 75 kph equivalent vehicle speed.

### DETAILED DESCRIPTION OF PREFERRED EMBODIMENT OF THE INVENTION

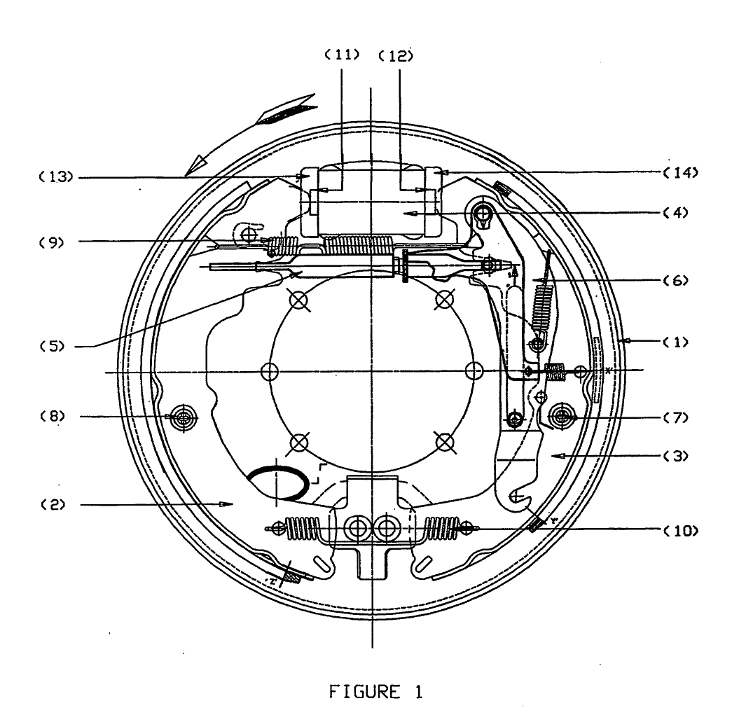

FIG. 1 illustrates the conventional drum brake now In use:

The drum brake assembly consists of a backplate (1), lined leading shoe (2), lined trailing Shoe (3), wheel cylinder assembly (4), strut assembly (5), handbrake lever (6), shoe hold down springs (7,8) and shoe return springs (9,10). The wheel cylinder assembly (4) is bolted to the backplate (1) and the lined leading shoe (2), lined trailing shoe (3) are assembled onto the backplate with the help of shoe hold down springs (7,8) and shoe return springs (9,10). When the wheel cylinder assembly (4) is pressurised, pistons (11,12) in the wheel cylinder (4) push the lined leading shoe (2) and lined trailing shoe (3), overcoming the shoe return springs (9,10) force and press the lined leading shoe (2) and lined trailing shoes (3) against the rotating brake drum. The drag force developed at the lined leading shoe (2) and lined trailing shoe (3) shoes against the brake drum slow down the wheel. When the pressure is removed, the shoe return springs (9,10) aid the retraction of the lined leading shoe (2) and lined trailing shoe (3), back to their normal (released) position and the wheels get free.

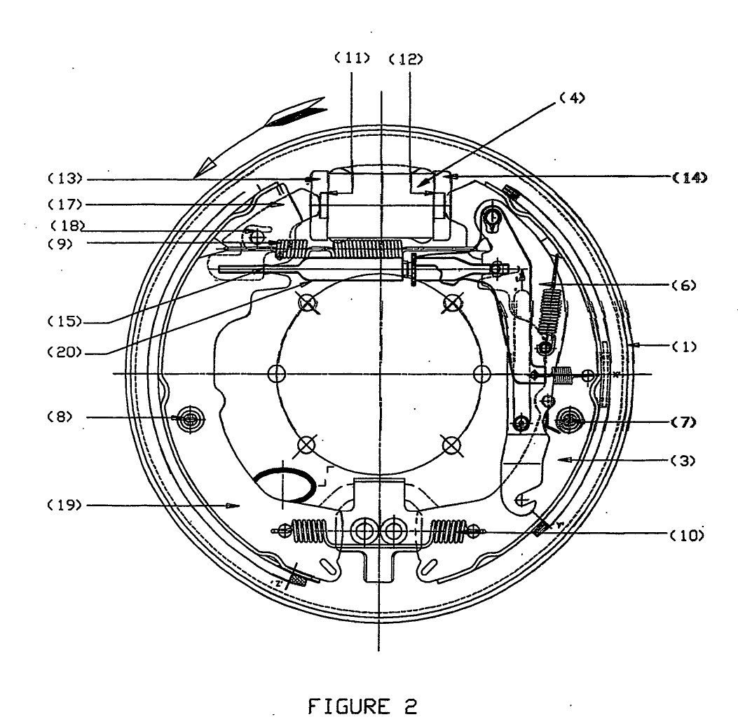

FIG. 2 illustrates the High Performance Drum brake assembly of the invention:

It is known in the art that the conventional drum brake assembly has a linear input-output relationship and amplification is attempted either by increasing the wheel cylinder diameter, friction level or the brake diameter per se. The salient feature of the invention is to provide a new lever on the leading shoe web whereby the output from the drum brake assembly can be enhanced. The invention envisages utilization of the space on the leading shoe web near the wheel cylinder and connected in such a way to the lined shoe to increase the brake output torque.

In order to incorporate this idea of space utilization in the existing drum brake assembly, a structural modification has to be effected in leading shoe web, the change details described are as follows:

The design of high performance drum brake assembly is illustrated in the FIG. 2 of the drawings. An additional new lever (17) is pivoted on the lined leading shoe (19) with one end resting on the wheel cylinder piston (11) and the other end on the strut assembly (15). This new lever (17) touches the wheel cylinder piston (11) instead of the lined leading shoe (19) and receives input from the pressurized wheel cylinder assembly (4).

The female push rod (20) of the strut assembly (15) is relieved at the entrance to take in the lined leading shoe (19) and the new lever (17) width at the entrance.

The new lever (17) is pivoted on the lined leading shoe (19) with one end resting on the wheel cylinder assembly (4) piston (11) and the other end on the strut assembly (15). This new lever (17) touches the wheel cylinder assembly (4) piston (11) instead of the lined leading shoe (19) and receives input from the pressurized wheel cylinder assembly (4).

Upon actuating the wheel cylinder assembly (4), the new lever (17) rotates about its pivot (18) point and pushes the strut assembly (15). The lined trailing shoe (3) now receives two inputs viz., one from the wheel cylinder assembly (4) and the other from the strut assembly (15), which is mechanically actuated by the new lever (17). The reaction from the lined trailing shoe (3) is passed via the strut assembly (15) as an Input to the lined leading shoe (19). The wheel cylinder assembly (4) input and the strut assembly (15) reaction force together acting on the pivot (18), results in almost twice the force acting on the leading shoe. The combined force from the wheel cylinder assembly (4) and the reaction from the strut assembly (15) acting on the pivot (18) point achieve equilibrium of the new lever (17). This brake design needs to have an auto-adjuster mechanism in place and should be operated through handbrake mechanism or through the service brake during pressure release.

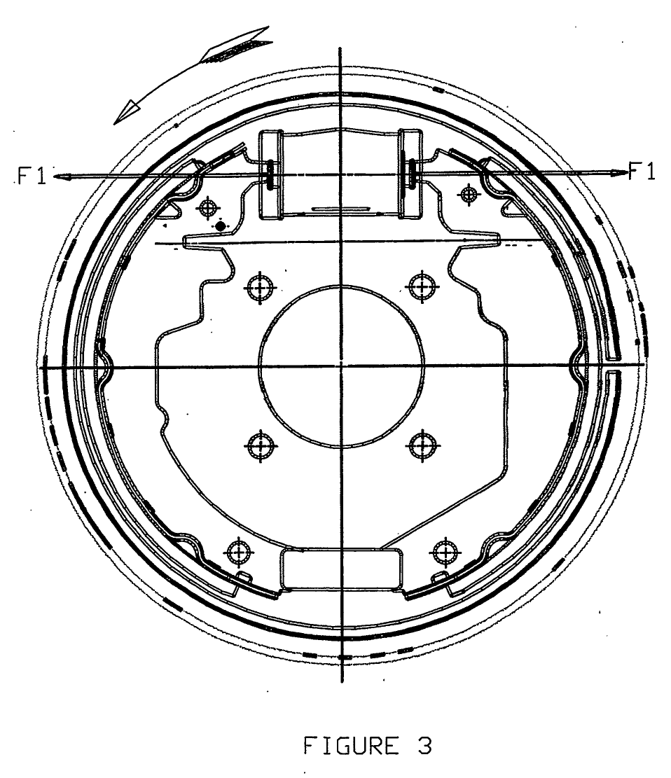

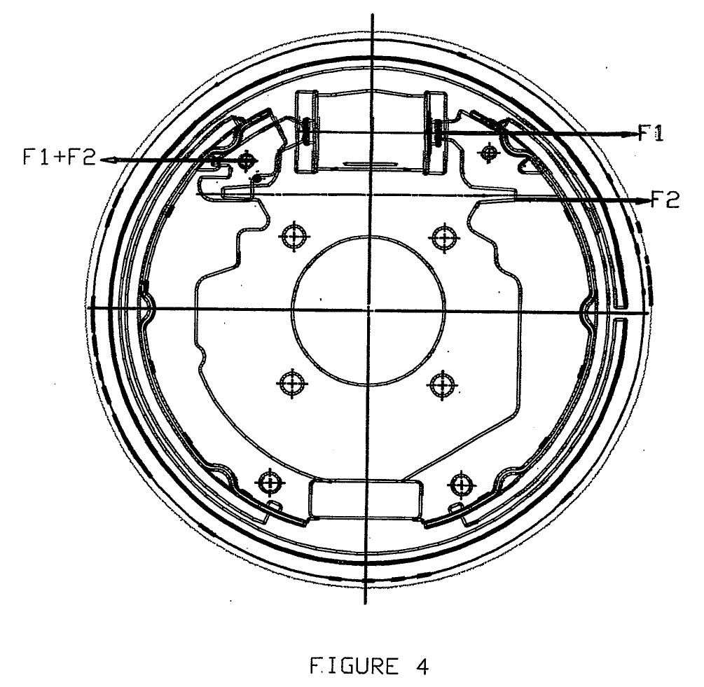

FIGS. 3 & 4 show the input forces from the wheel cylinder assembly (4) acting on the lined leading shoe (19) and lined trailing shoe (3) for the known drum brake assembly and the high performance drum brake assembly.

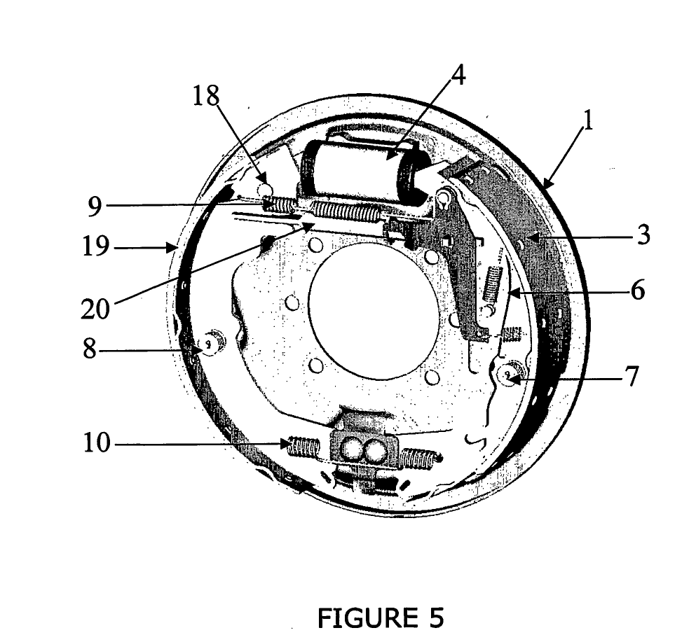

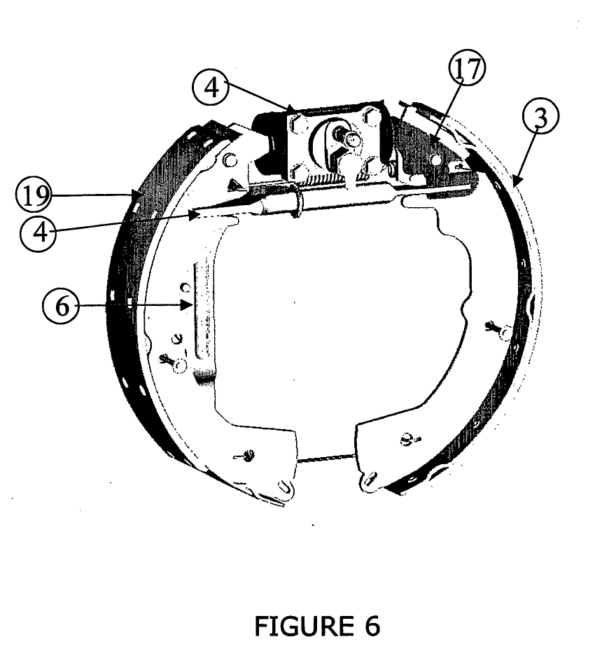

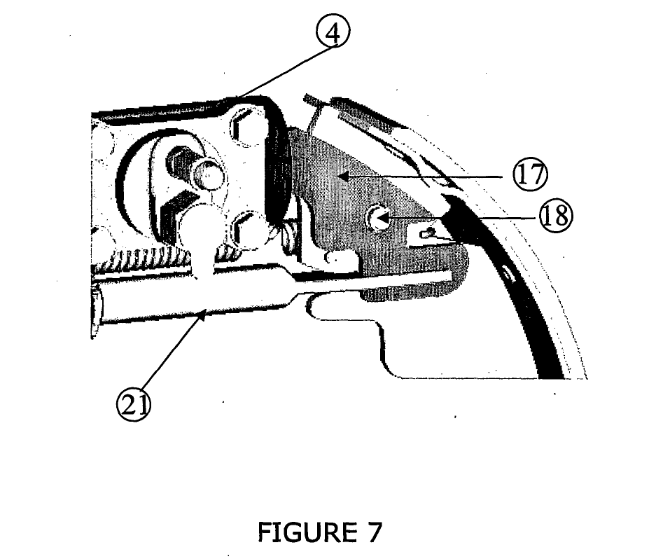

FIGS. 5,6 and 7 show the 3D models of the high performance drum brake assembly indicating assembly of various parts constituting the invented drum brake assembly. FIG. 6 depicts the assembly of the new lever in the brake assembly. FIG. 7 gives the close-up view of the lever arrangement on to the lined leading shoe assembly.

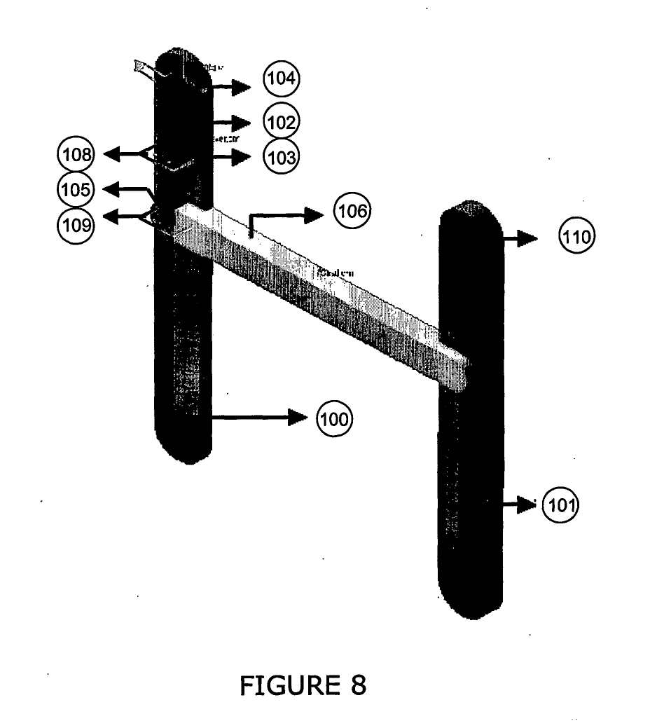

To validate the principle, a simple link model representative of the drum brake assembly is simulated using the software Adams/View 12.0 and is shown in FIG. 8. The lined leading shoe and lined trailing shoe are represented by links 100 and 101 respectively. Having grounded the links 100 & 101, the strut (106) is positioned across the links. The new lever (102) is pivoted (103) to the link (100) with one end resting at the wheel cylinder input (104) and the other end resting at the strut input end (105). The above geometry is built in Adams/View 12.0 for kinematic simulation to understand the force transfer mechanism.

The new lever (102) is pivoted to the link (100) by means of a revolute joint (108). For transfer of force from the new lever (102) to the strut (106), a translational joint (109) is provided.

For simulation purposes, an input force is given to the new lever (102) and also to the link (101) as shown. Upon simulation, the output forces are captured at the joint (108) and along the strut (106) axis.

Compared to the known drum brake design, the Adams simulation also validates our above discussion in terms of force amplification to the links 100 and 101. Link (100) receives almost twice the force at the joint (108) and the link (101) receives force via the strut (106) axis in addition to the wheel cylinder input force (110).

### Salient Features of the High Performance Drum Brake Assembly

1) The High Performance drum brake assembly for automotive braking system has an additional lever positioned on the leading shoe web and touches the wheel cylinder piston.
2) Compared to a identical design, the High Performance drum brake assembly gives increased braking torque for a given pipe line pressure or needs substantially reduced pipe line pressure to realize the design rated brake torque.

To validate the high performance design, a prototype sample of φ282×50.8 mm hydraulic auto-adjust service, forward pull brake with the new feature was developed for the test purpose. A conventional φ282×50.8 mm hydraulic auto-adjust, service, forward pull drum brake assembly is also taken up for testing to compare the differences in brake output torque. The wheel cylinder diameter, friction lining area, friction lining grade and the test inertia for the conventional and the high performance design are maintained identical for the dynamometer test.

Inertia dynamometer test was carried out on the conventional design and also on the high performance design to compare the input-output relationships.

Dynamometer test was carried out at different vehicle equivalent speeds and pressure levels. Hydraulic pressures of 20 bar to 80 bar in steps of 10 bar is applied to the drum brake assembly at each speed level and at an initial braking temperature of 80° C. The input hydraulic pressure and the brake output torque at each speed/pressure level is recorded and presented graphically.

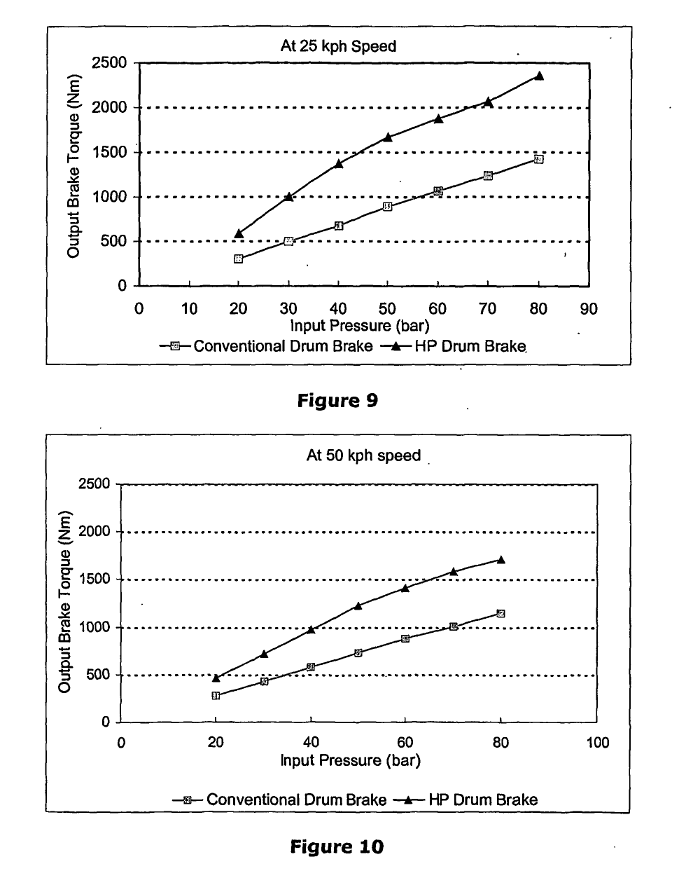

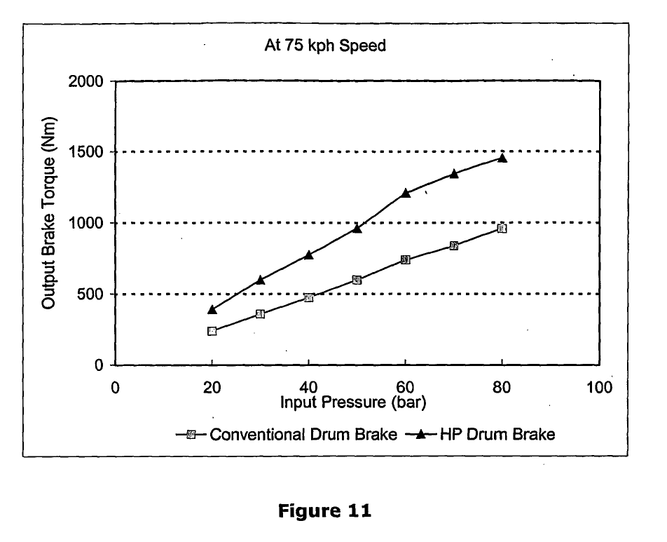

FIGS. 9, 10 & 11 gives the relationship between input hydraulic pressure and the brake output torque for the conventional design and the high performance design at vehicle equivalents speeds of 50 kph and 75 kph respectively. For the conventional design, the graph indicating the input pressure and the output brake torque is shown with a square legend. For the same test conditions, the output obtained with the novel design is shown with a triangle legend. An average increase of about 60% in brake output torque with the high performance design for the same pressure input can be observed from the test results. Reverse direction performance was also carried out and an average increase of about 40% in brake output torque is realized. The increase in output agrees with the theoretical prediction and the marginal difference is attributed to pivot friction loss, drum deflection, friction material sensitivity to speed, pressure and temperature.

The increase in brake torque with the High Performance design for the above test parameters is clearly ascribed to the newly developed concept as explained in the detailed description of preferred embodiment of the invention.

The output brake torque obtained in the High Performance design is substantially higher than the conventional brakes.

Generally, when brakes are proposed for heavier applications, the brake size (diameter) increase to cater to the higher brake torque. However, in view of this newly developed drum brake assembly, as the external dimensions are retained, compactness in packaging can easily be addressed.

While the above description contains many specificities, these should not be construed as limitations in the scope of the invention, but rather as an exemplification of one preferred embodiment thereof. The terms and expressions in this specification are of description and not of limitation, since there is no intention to exclude any equivalents of the features illustrated and described, but it is understood that various other embodiments of this invention is possible, without departing from the scope and ambit thereof. For example, the invention “High Performance Drum Brake” design needs lower pressure for the existing brake output torque and hence optimization of wheel cylinder housing wall thickness is possible. Also, the same design can well be extended to air operated drum brake assemblies to enhance the brake output torque for a given input air pressure.

It is to be noted that the invention “High Performance Drum Brake” delivers brake torque substantially higher than the existing drum brake assembly, without the necessity of increasing the drum brake size or the wheel size, which results in material savings, cost savings and compactness in packaging.

Accordingly, the scope of the invention should be determined not by the embodiments illustrated, but by the appended claims and their legal equivalents.

### Advantages of the Invention

1) The High Performance design extended onto a conventional drum brake assembly gives increased braking torque for a given pipe line pressure or needs substantially reduced pipe line pressure to realize the design rated brake torque.
2) The High Performance design can be extended to any type/form of drum brake assemblies currently in existence.
3) For equivalent design consideration, the High Performance drum brake design/assembly is compact in terms of packaging.
4) For equivalent design consideration, the High Performance drum brake design/assembly can use a low friction linings to deliver the design rated brake torque.
5) For equivalent design consideration, the High Performance drum brake design/assembly can use a smaller wheel cylinder diameter to deliver the design rated brake torque.
6) For equivalent design consideration, the High Performance drum brake assembly can utilize a low friction lining due to the increased output given by the brake assembly through which a host of issues such as maintaining lining performance consistency, grabbing, high fade, noise, early morning sharpness can be easily addressed.

1-12. (canceled)

13. A high performance drum brake assembly for automotive braking system, comprises of a cylinder assembly, back plate, strut assembly, lined leading shoe, lined heading shoe and a lever assembly characterized in that the lever is pivotally inclined to the lined leading shoe such that the rear end of the lever is sustained by the strut positioned at the upper end of the brake drum

14. The high performance drum brake assembly according to claim 3 wherein the fore end of the lever is sustained by a piston and a pressurized input is supplied to the lever on actuating the wheel cylinder assembly.

15. The high performance drum brake assembly according to claim 13, comprising of a backplate, lined leading shoe, lined trailing shoe, shoe return springs, handbrake lever and shoe hold down springs wherein on actuating the wheel cylinder assembly the lever rotates about its pivot and actuates the strut assembly so as that lined trailing shoe receives inputs from both the wheel cylinder and strut assembly.

16. The high performance drum brake assembly, as claimed in claim 15, wherein, strut assembly actuates the lined trailing shoe that in-turn actuates the lined leading shoe such that resultant force acting on the leading shoe is atleast twice that of the input and results in low friction lining.

17. The high performance drum brake assembly according to claim 15 wherein the wheel cylinder is fixed to the backplate by means of mounting screws and the lined shoe assemblies are held to the backplate by means of shoe hold springs that are held together with the help of shoe return springs.
